(19) United States
(12) Patent Application Publication
(10) Pub. No.: US 2026/0160990 A1
(43) Pub. Date: Jun. 11, 2026

(54) Variable Wavelength Interference Filter, Optical Module, And Method For Driving Variable Wavelength Interference Filter

(71) Applicant: SEIKO EPSON CORPORATION, Tokyo (JP)

(72) Inventor: Kei KUDO, Shiojiri (JP)

(21) Appl. No.: 19/412,251

(22) Filed: Dec. 8, 2025

(30) Foreign Application Priority Data
Dec. 9, 2024 (JP) 2024-214209

(51) Int. Cl. G02B 26/00; G02B 5/28

(52) U.S. Cl. CPC G02B 26/007; G02B 5/28

(57) ABSTRACT

A variable wavelength interference filter includes a first reflection film and a second reflection film facing each other; and an electrostatic actuator that changes a gap length between the first reflection film and the second reflection film, and the electrostatic actuator includes a bias electrode to which a bias voltage corresponding to a target value of the gap length (that is, gap target value) is applied, a control electrode to which a control voltage subjected to feedback control in accordance with the gap length is applied, and a variable electrode to which one of the bias voltage and the control voltage is applied in a switchable manner.

The present application is based on, and claims priority from JP Application Serial Number 2024-214209, filed Dec. 9, 2024, the disclosure of which is hereby incorporated by reference herein in its entirety.

### BACKGROUND

### 1. Technical Field

The present disclosure relates to a variable wavelength interference filter, an optical module, and a method for driving the variable wavelength interference filter.

### 2. Related Art

There is a variable wavelength interference filter of related art including a pair of reflection films facing each other and an electrostatic actuator that changes a gap length between the pair of reflection films (refer, for example, to JP-A-2018-128681). The variable wavelength interference filter can transmit or reflect light having a desired wavelength by adjusting the gap length between the pair of reflection films.

In the variable wavelength interference filter disclosed in JP-A-2018-128681, the electrostatic actuator has multiple drive electrodes controlled in terms of voltage independently of each other. Specifically, the electrostatic actuator includes a bias electrode to which a bias voltage corresponding to a target value of the gap between the pair of reflection films is applied, and a control electrode to which a control voltage subjected to feedback control is applied based on the gap length and the target value of the gap described above. The variable wavelength interference filter allows fine wavelength adjustment in a wide wavelength band by using the bias electrode for coarse adjustment of the gap length and using the control electrode for fine adjustment of the gap length.

JP-A-2018-128681 is an example of the related art.

The variable wavelength interference filter disclosed in JP-A-2018-128681 described above, however, has an unsolved problem of a non-linear behavior of the voltage sensitivity of the electrostatic actuator with respect to the gap length between the pair of reflection films, so that the accuracy of the wavelength adjustment in a wide wavelength band is insufficient. For example, when the gap length is large, the sensitivity of the electrostatic actuator with respect to the voltage decreases, so that the electrostatic actuator is likely to be affected by disturbance. When the gap length is small, the sensitivity of the electrostatic actuator with respect to the voltage increases, so that it is difficult to make fine adjustment of the gap length.

### SUMMARY

A variable wavelength interference filter according to a first aspect the present disclosure includes: a pair of reflection films facing each other; and an electrostatic actuator configured to change a gap length between the pair of reflection films, and the electrostatic actuator includes a bias electrode to which a bias voltage corresponding to a target value of the gap length is applied, a control electrode to which a control voltage subjected to feedback control based on the gap length and the target value is applied, and a variable electrode to which one of the bias voltage and the control voltage is applied in a switchable manner.

An optical module according to a second aspect of the present disclosure includes the variable wavelength interference filter described above; and a filter driver configured to drive the electrostatic actuator, and the filter driver includes a bias driver configured to apply the bias voltage to the bias electrode, a gap detector configured to detect the gap length between the pair of reflection films, a feedback controller configured to apply the control voltage to the control electrode based on the gap length detected by the gap detector, and a voltage switcher configured to apply one of the bias voltage and the control voltage to the variable electrode in a switchable manner.

A method for driving a variable wavelength interference filter according to a third aspect of the present disclosure includes: changing a gap length between a pair of reflection films by applying a bias voltage corresponding to a target value of the gap length to a bias electrode; adjusting the gap length between the pair of reflection films by detecting the gap length and applying a control voltage subjected to feedback control based on the detected gap length and the target value to a control electrode; selecting one of the bias voltage and the control voltage as a selected voltage based on the target value; and assisting a change or adjustment of the gap length by applying the selected voltage to a variable electrode at the time of voltage application to the bias electrode or the control electrode.

### BRIEF DESCRIPTION OF THE DRAWINGS

FIG. 1 is a block diagram showing a schematic configuration of a spectrometric apparatus according to an embodiment of the present disclosure.

FIG. 2 is a cross-sectional view diagrammatically showing a variable wavelength interference filter according to the embodiment.

FIG. 3 is a plan view diagrammatically showing the electrode arrangement at a second substrate of the variable wavelength interference filter according to the embodiment.

FIG. 4 is a flowchart showing a method for driving the variable wavelength interference filter according to the embodiment.

FIG. 5 shows graphs illustrating changes in voltage sensitivity in the variable wavelength interference filter according to the embodiment.

FIG. 6 shows graphs illustrating changes in bias voltage value in the variable wavelength interference filter according to the embodiment.

FIG. 7 is a cross-sectional view diagrammatically showing a variable wavelength interference filter according to a variation.

FIG. 8 is a cross-sectional view diagrammatically showing a variable wavelength interference filter according to another variation.

### DESCRIPTION OF EMBODIMENTS

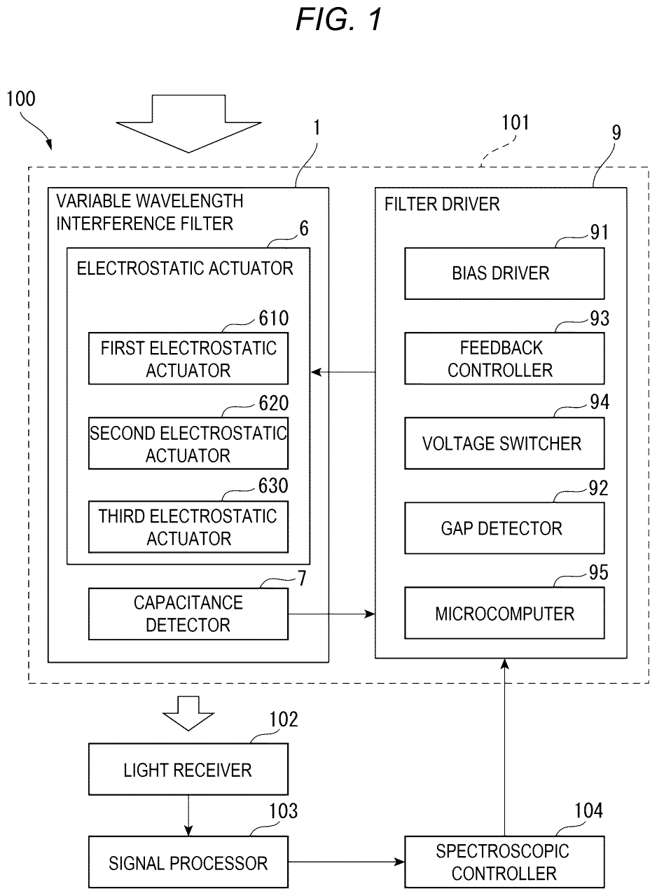

An embodiment of the present disclosure will be described with reference to FIGS. 1 to 6.

A spectrometry apparatus 100 in the present embodiment includes an optical module 101, a light receiver 102, a signal processor 103, and a spectroscopic controller 104, and the optical module 101 includes a variable wavelength interference filter 1 and a filter driver 9, as shown in FIG. 1. The spectrometry apparatus 100 is an apparatus that separates measurement light incident from a measurement target in terms of wavelength with the variable wavelength interference filter 1, receives the separated measurement light with the light receiver 102, and analyzes the intensity of the light reflected off the measurement target and having a predetermined wavelength to perform optical spectrum measurement. The spectrometry apparatus 100 can be incorporated in various instruments such as a printer, a projector, and a drone and used accordingly.

### Configuration of Variable Wavelength Interference Filter 1

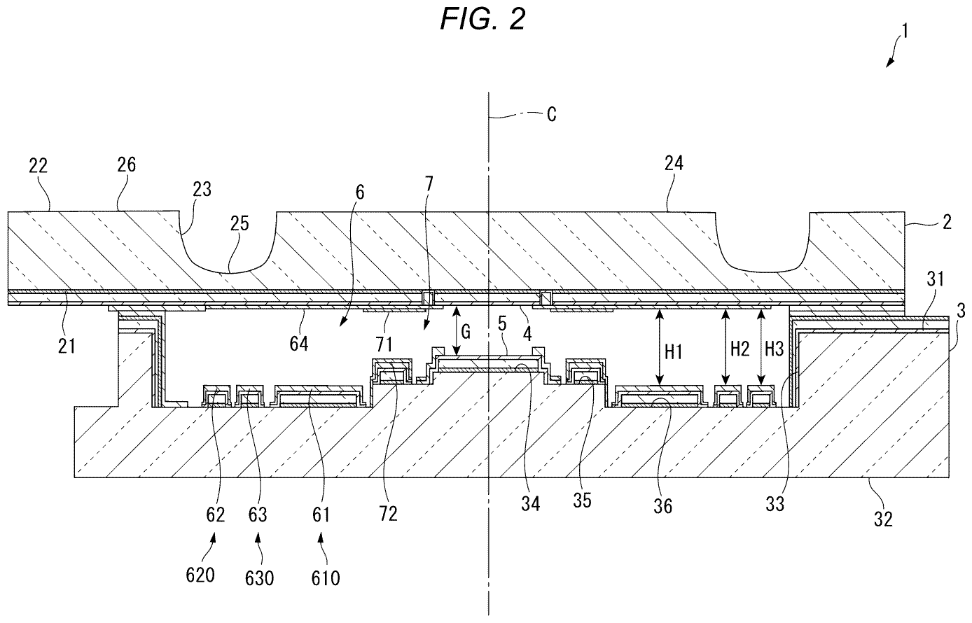

FIG. 2 is a cross-sectional view showing the variable wavelength interference filter 1 according to the present embodiment. The variable wavelength interference filter 1 is a spectral filter capable of changing the wavelength of the light passing therethrough in accordance with an externally input drive voltage.

The variable wavelength interference filter 1 includes a first substrate 2 and a second substrate 3 disposed to face each other, a first reflection film 4 provided at the first substrate 2, a second reflection film 5 provided at the second substrate 3, an electrostatic actuator 6, which changes the dimension of a gap (hereinafter referred to as gap length G) between the first reflection film 4 and the second reflection film 5, and a capacitance detector 7, which detects the gap length G.

Note in the following description that the direction in which the first substrate 2 and the second substrate 3 face each other (that is, thickness direction of each of first substrate 2 and second substrate 3) is referred to as a thickness direction of the variable wavelength interference filter 1. FIG. 2 corresponds to a cross-sectional view of the variable wavelength interference filter 1 taken along the thickness direction thereof.

The first substrate 2 and the second substrate 3 are each made of a material capable of transmitting light, such as various types of glass and quartz crystal. The first substrate 2 and the second substrate 3 are bonded to each other into a structure that forms a cavity therebetween.

The first substrate 2 has a first surface 21 facing the second substrate 3, and a second surface 22 opposite the first surface 21. When the first substrate 2 is viewed along the thickness direction, an annular groove 23 is formed at the second surface 22 of the first substrate 2. The thus configured first substrate 2 includes a movable portion 24, which is a portion surrounded by the annular groove 23, a diaphragm portion 25, which is a portion thinned by the groove 23, and a base portion 26, which supports the movable portion 24 via the diaphragm portion 25 so as to be displaceable in the thickness direction. The base portion 26 of the first substrate 2 is bonded to the second substrate 3 via a bonding film of any kind.

The second substrate 3 has a third surface 31 facing the first substrate 2, and a fourth surface 32 opposite the first surface 31. A recess 33, which forms the cavity between the first substrate 2 and the second substrate 3, is formed in a central portion of the third surface 31. A reflection film placement portion 34, a detection electrode placement portion 35, and a drive electrode placement portion 36 are formed at the bottom surface of the recess 33 of the second substrate 3. The reflection film placement portion 34 is disposed at a central portion of the recess 33, and the detection electrode placement portion 35 and the drive electrode placement portion 36 are each disposed in an annular shape surrounding the reflection film placement portion 34. The reflection film placement portion 34, the detection electrode placement portion 35, and the drive electrode placement portion 36 are formed in accordance with an initially set distance from the first substrate 2, and may each have a pedestal shape or a groove shape.

The first reflection film 4 is provided at the first surface 21 of the movable portion 24 of the first substrate 2, and the second reflection film 5 is provided at the reflection film placement portion 34 of the second substrate 3. The first reflection film 4 and the second reflection film 5 face each other via the gap, and an axial line passing through the centers of the first reflection film 4 and the second reflection film 5 is called a center axis C of the variable wavelength interference filter 1. When the variable wavelength interference filter 1 is viewed along the thickness direction, a region where the first reflection film 4 and the second reflection film 5 overlap with each other forms a filter region of the variable wavelength interference filter 1, and the filter region has a substantially circular shape around the center axis C. The gap length G between the first reflection film 4 and the second reflection film 5 corresponds to the wavelength of light passing through the filter region of the variable wavelength interference filter 1.

Note that each of the first reflection film 4 and the second reflection film 5 in the present embodiment is not limited to a specific film, and is a dielectric multilayer film having a configuration in which Si layers (silicon layers) and SiO₂ layers (silicon oxide layers) are alternately layered on each other.

The electrostatic actuator 6 in the present embodiment attracts the movable portion 24 of the first substrate 2 toward the second substrate 3 to change the gap length G between the first reflection film 4 and the second reflection film 5. The electrostatic actuator 6 includes a bias electrode 61, a control electrode 62, and a variable electrode 63 as multiple drive electrodes to which drive voltages are applied. The bias electrode 61, the control electrode 62, and the variable electrode 63 are provided at the drive electrode placement portion 36 of the first substrate 2. Specifically, the bias electrode 61 is disposed to face the movable portion 24, and the variable electrode 63 and the control electrode 62 are disposed to face the diaphragm portion 25. The electrostatic actuator 6 further includes a ground electrode 64 provided at the first surface 21 of the first substrate 2 so as to face each of the bias electrode 61, the control electrode 62, and the variable electrode 63.

Note in the present embodiment that distances H1 to H3 of the spaces from the bias electrode 61, the control electrode 62, and the variable electrode 63 to the ground electrode 64 are equal to each other, but may differ from each other. In the present embodiment, the distances H1 to H3 of the spaces from the bias electrode 61, the control electrode 62, and the variable electrode 63 to the ground electrode 64 are greater than the gap length G between the first reflection film 4 and the second reflection film 5, but not necessarily, and the distances H1 to H3 may be smaller than the gap length G.

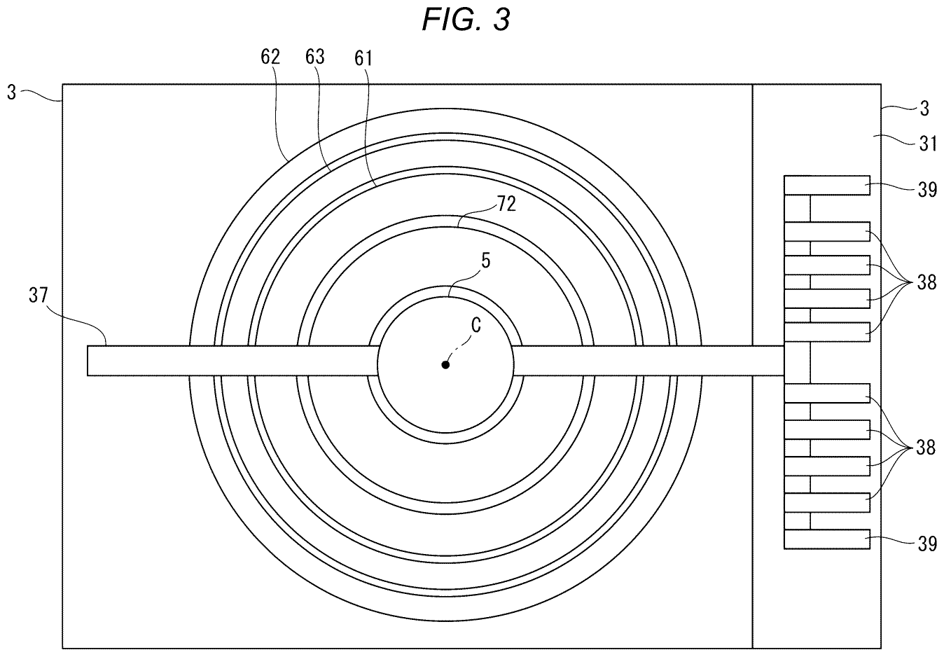

FIG. 3 is a plan view of the second substrate 3 when viewed along the thickness direction, and diagrammatically shows the arrangement of the electrodes at the third surface 31 of the second substrate 3. When the second substrate 3 is viewed along the thickness direction, the bias electrode 61, the control electrode 62, and the variable electrode 63 are disposed around the second reflection film 5, and are disposed concentrically around the center axis C, as shown in FIG. 3. The electrodes at the second substrate 3 in the electrostatic actuator 6 are arranged outward in the radial direction from the side facing the second reflection film 5 in the following order: the bias electrode 61; the variable electrode 63; and the control electrode 62.

Note in the present embodiment that the area of the bias electrode 61 is preferably greater than the area of each of the control electrode 62 and the variable electrode 63, and greater than the sum of the areas of the control electrode 62 and the variable electrode 63.

Although will be described later in detail, the bias electrode 61 and the ground electrode 64 constitute a first electrostatic actuator 610, to which a bias voltage is applied. The control electrode 62 and the ground electrode 64 constitute a second electrostatic actuator 620, to which a control voltage is applied. The variable electrode 63 and the ground electrode 64 constitute a third electrostatic actuator 630, to which one of the bias voltage and the control voltage is applied in a switchable manner. The first electrostatic actuator 610 and the second electrostatic actuator 620 are driven in a controlled manner independently of each other, and the operation mode of the third electrostatic actuator 630 is switched between a bias drive mode in which the third electrostatic actuator 630 and the first electrostatic actuator 610 are driven in a controlled manner and a feedback control mode in which the third electrostatic actuator 630 and the second electrostatic actuator 620 are driven in a controlled manner.

The capacitance detector 7 includes a first detection electrode 71 provided at the first surface 21 of the first substrate 2, and a second detection electrode 72 provided at the detection electrode placement portion 35 of the second substrate 3 and facing the first detection electrode 71, and holds electric charge according to the gap length G between the first detection electrode 71 and the second detection electrode 72, as shown in FIG. 2. When the variable wavelength interference filter 1 is viewed along the thickness direction, the first detection electrode 71 and the second detection electrode 72 are each disposed in an annular shape around the center axis C so as to surround the corresponding one of the first reflection film 4 and the second reflection film 5. The first detection electrode 71 is disposed between the first reflection film 4 and the ground electrode 64, and the second detection electrode 72 is disposed between the second reflection film 5 and the bias electrode 61.

The bias electrode 61, the control electrode 62, the variable electrode 63, and the ground electrode 64 in the present embodiment are each configured with, but not limited to, a metal oxide film made, for particularly example, of indium tin oxide (ITO) and layered on a dielectric multilayer film. The first detection electrode 71 and the second detection electrode 72 are each configured with a metal film made, for example, of Au and layered on a dielectric multilayer film and a metal oxide film made, for example, of indium tin oxide (ITO).

The bias electrode 61, the control electrode 62, the variable electrode 63, and the second detection electrode 72 in the electrostatic actuator 6 described above are electrically coupled to multiple drive electrode terminals 38 disposed outside the cavity via a lead-out wiring portion 37 formed at the second substrate 3, as shown in FIG. 3. Although shown in a simplified manner in FIG. 3, the lead-out wiring portion 37 and the drive electrode terminals 38 are configured to allow independent voltage application to each of the bias electrode 61, the control electrode 62, the variable electrode 63, and the second detection electrode 72. The drive electrode terminals 38 are coupled to the external filter driver 9 (see FIG. 1) via any wiring structure that is not shown.

The ground electrode 64 and the first detection electrode 71 at the first substrate 2 are electrically coupled to common electrode terminals 39 disposed outside the cavity via wires (through wires, lead-out wires, or other wires of first substrate 2) that are not shown. The common electrode terminals 39 are grounded.

### Filter Driver 9

The filter driver 9 will be described with reference to FIG. 1 again. The filter driver 9 is a circuit that drives the variable wavelength interference filter 1 described above in a controlled manner, and includes a bias driver 91, a gap detector 92, a feedback controller 93, a voltage switcher 94, and a microcomputer 95.

The bias driver 91 applies the bias voltage at least to the first electrostatic actuator 610 (specifically, bias electrode 61 in FIG. 2). The bias voltage is a voltage corresponding to a target value of the gap length G (hereinafter referred to as gap target value Gt), and a voltage value of the bias voltage is set in the bias driver 91 based on a bias signal input from the microcomputer 95. Note that the bias driver 91 is configured, for example, with a D/A converter having a predetermined number of bits.

The gap detector 92 acquires a detection signal according to the gap length G from the capacitance detector 7, and outputs the acquired detection signal to the feedback controller 93.

The feedback controller 93 applies the control voltage at least to the second electrostatic actuator 620 (specifically, control electrode 62 in FIG. 2). Specifically, the feedback controller 93 outputs the control voltage subjected to feedback control based on the detection signal input from the gap detector 92 (that is, in accordance with gap length G) and a target signal input from the microcomputer 95 in a way that the signals have the same value. Note that the feedback controller 93 may be configured with an analog control device having a fixed gain, and that the voltage variable range may be set to have a predetermined width. The analog control device can, for example, be a PI control device or a PID control device.

The voltage switcher 94 applies one of the bias voltage and the control voltage to the third electrostatic actuator 630 (specifically, variable electrode 63 in FIG. 2) in a switchable manner. That is, the voltage switcher 94 can switch the operation mode of the third electrostatic actuator 630 between the bias drive mode and the feedback control mode. For example, the voltage switcher 94 in the present embodiment is a switch capable of switching the destination to which the variable electrode 63 is coupled between the bias driver 91 and the feedback controller 93 based on a switching signal input from the microcomputer 95.

The microcomputer 95 controls each of the bias driver 91, the feedback controller 93, and the voltage switcher 94 in accordance with a target wavelength instructed from the spectroscopic controller 104.

### Spectrometry Apparatus 100

The configuration of the spectrometry apparatus 100 excluding the optical module 101 will be described.

The light receiver 102 is a sensor that receives the light having passed through the variable wavelength interference filter 1. The light receiver 102 can, for example, be an image sensor such as a CCD or CMOS sensor. When the light receiver 102 receives the light having passed through the variable wavelength interference filter 1, the light receiver 102 outputs a light reception signal according to the amount of the received light to the spectroscopic controller 104.

The signal processor 103 includes a sampling circuit that samples the light reception signal output from the light receiver 102, an amplification circuit that amplifies the light reception signal, an A/D conversion circuit that converts the light reception signal into a digital signal, and other circuits. The signal processor 103 performs signal processing on the light reception signal with the aid of the circuits described above, and inputs the light reception signal having undergone the signal processing to the spectroscopic controller 104.

The spectroscopic controller 104 is configured, for example, with a combination of a CPU, a memory, and other elements, and controls an entire operation of the spectrometry apparatus 100. The spectroscopic controller 104 instructs the filter driver 9 to start spectrometry based, for example, on externally input information, and performs spectrometry on the measurement target based on the light reception signal input from the signal processor 103.

### Method for Driving Variable Wavelength Interference Filter 1

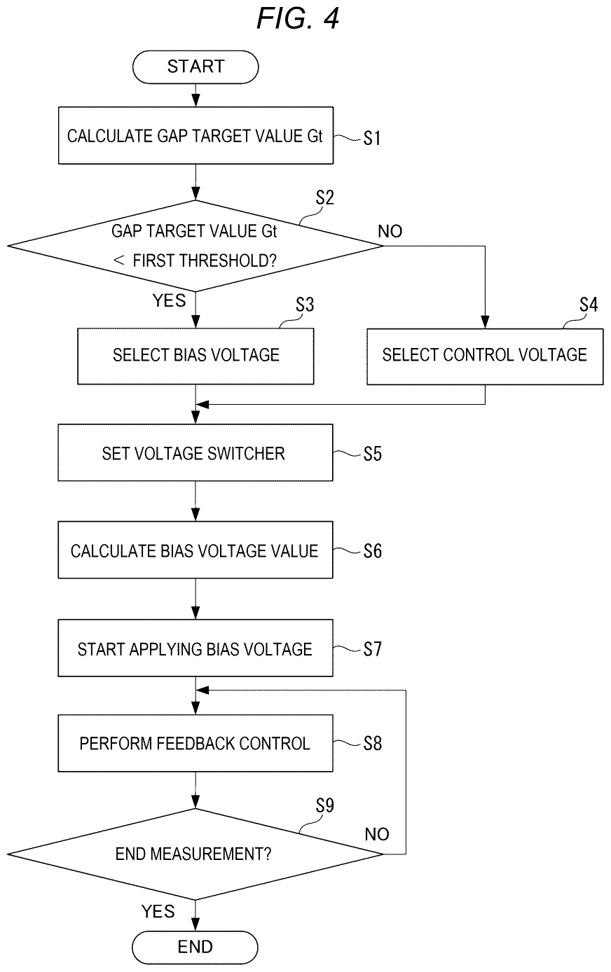

A method for driving the variable wavelength interference filter 1 according to the present embodiment will next be described with further reference to the flowchart in FIG. 4. Note that a case where the spectrometry is performed with a target wavelength being any one wavelength will be described below by way of example.

The spectroscopic controller 104 outputs a control signal indicating the target wavelength to the filter driver 9 in accordance, for example, with a user's operation. When the control signal is input from the spectroscopic controller 104, the microcomputer 95 calculates the target value of the gap length G (gap target value Gt) necessary for extracting the light having the target wavelength from the variable wavelength interference filter 1 (step S1).

The microcomputer 95 determines whether the gap target value Gt is smaller than a predetermined first threshold (step S2), and selects, based on the result of the comparison, one of the bias voltage and the control voltage as a selected voltage to be applied to the variable electrode 63. For example, when the gap target value Gt is smaller than the predetermined first threshold (Yes in step S2), the microcomputer 95 selects the bias voltage as the selected voltage to be applied to the variable electrode 63 (step S3). When the gap target value Gt is greater than or equal to the predetermined first threshold (No in step S2), the microcomputer 95 selects the control voltage as the selected voltage to be applied to the variable electrode 63 (step S4). The microcomputer 95 then outputs a switching signal corresponding to the selected voltage to the voltage switcher 94. The switching and coupling operation performed by the voltage switcher 94 is thus set, so that the third electrostatic actuator 630 is set to operate in the bias drive mode or the feedback control mode (step S5).

The microcomputer 95 calculates the voltage value of the bias voltage (hereinafter referred to as bias voltage value V_{b}) corresponding to the gap target value Gt (step S6). In this process, the microcomputer 95 can calculate the bias voltage value V_{b} corresponding to the gap target value Gt by referring to an expression or a drive table stored in a memory that is not shown. The microcomputer 95 then outputs a bias signal indicating the bias voltage value V_{b} to the bias driver 91.

The expression used to calculate the bias voltage value V_{b} can, for example, be the following expression (1) disclosed in JP-A-2018-128681.

$${V}_{b} = {[ \frac{k}{ε {S}_{b}} \{ 2 {d ( {d}_{max} - d )}^{2} + \frac{{{kR}_{c}^{2} ( {d}_{max} - d )}^{2} {( {d}_{max} - 3 d )}^{2}}{ε {S}_{c}} \} ]}^{1 / 2} \qquad ( 1 )$$

In Expression (1) described above, k is a spring coefficient of the second substrate 3, ε is the permittivity of the gap between the first reflection film 4 and the second reflection film 5, S_{b} is an area of an electrode region to which the bias voltage is applied, the area being an area in a plan view of the variable wavelength interference filter 1 viewed in the thickness direction, S_{c} is an area of an electrode region to which the control voltage is applied, the area being an area in the plan view of the variable wavelength interference filter 1 viewed in the thickness direction, dₘₐₓ is an initial gap length, d is the amount of change in target length that is a difference between the initial gap length and the gap target value Gt, and R_{c} is the sensitivity of the electrode to which the control voltage is applied.

Note that the area S_{c} of the electrode region to which the bias voltage is applied and the area S_{c} of the electrode region to which the control voltage is applied change in accordance with the setting of the voltage switcher 94 (that is, whether third electrostatic actuator 630 operates in bias drive mode or feedback control mode). When the third electrostatic actuator 630 operates in the bias drive mode, the area S_{c} of the electrode region to which the bias voltage is applied corresponds to the sum of the areas of the bias electrode 61 and the variable electrode 63, and the area S_{c} of the electrode region to which the control voltage is applied corresponds to the area of the control electrode 62. When the third electrostatic actuator 630 operates in the feedback control mode, the area S_{c} of the electrode region to which the bias voltage is applied corresponds to the area of the bias electrode 61, and the area S_{c} of the electrode region to which the control voltage is applied corresponds to the sum of the areas of the control electrode 62 and the variable electrode 63. It is therefore preferable that the microcomputer 95 calculates the area S_{c} of the electrode region to which the bias voltage is applied and the area S_{c} of the electrode region to which the control voltage is applied based on the setting of the voltage switcher 94 set in step S5, and calculates the bias voltage value V_{b} by using the calculated areas.

The bias driver 91 then starts applying the bias voltage based on the bias signal input from the microcomputer 95 (step S7).

When the third electrostatic actuator 630 operates in the bias drive mode, the bias voltage output from the bias driver 91 is applied to each of the bias electrode 61 and the variable electrode 63. When the third electrostatic actuator 630 operates in the feedback control mode, the bias voltage output from the bias driver 91 is applied to the bias electrode 61.

An electrostatic attractive force based on the bias voltage therefore acts in the first electrostatic actuator 610 (and third electrostatic actuator 630), so that the movable portion 24 is displaced toward the second substrate 3 to change the gap length G.

The feedback controller 93 outputs the control voltage in a way that the detection signal input from the gap detector 92 and the t target signal input from the microcomputer 95 have the same value (step S8).

When the third electrostatic actuator 630 operates in the bias drive mode, the control voltage output from the feedback controller 93 is applied to the control electrode 62. When the third electrostatic actuator 630 operates in the feedback control mode, the control voltage output from the bias driver 91 is applied to each of the control electrode 62 and the variable electrode 63.

An electrostatic attractive force based on the control voltage therefore acts in the second electrostatic actuator 620 (and third electrostatic actuator 630), so that the displacement of the movable portion 24 (that is, gap length G) undergoes fine adjustment.

After step S8, the filter driver 9 applies the bias voltage and the control voltage until the filter driver 9 receives an end instruction to control the gap length G in a way that the variable wavelength interference filter 1 transmits the light having the target wavelength (step S9).

Note that while the gap length G of the variable wavelength interference filter 1 is controlled, the light receiver 102 detects the light having passed through the variable wavelength interference filter 1, and the spectroscopic controller 104 acquires the light reception signal from the light receiver 102 via the signal processor 103. The spectroscopic controller 104 then calculates an optical characteristic value for the target wavelength of the light from the measurement target based on the acquired light reception signal.

To measure the optical spectrum corresponding to each of wavelengths set at predetermined intervals in a measured wavelength range, steps S1 to S9 described above may be repeated for each of the wavelengths. For example, when the gap target value Gt is changed for each of the predetermined intervals, the third electrostatic actuator 630 may be set to operate in the bias drive mode in a range within which the gap target value Gt is smaller than the first threshold, and the third electrostatic actuator 630 may be set to operate in the feedback control mode in a range within which the gap target value Gt is greater than or equal to the first threshold.

### Operation of Electrostatic Actuator 6

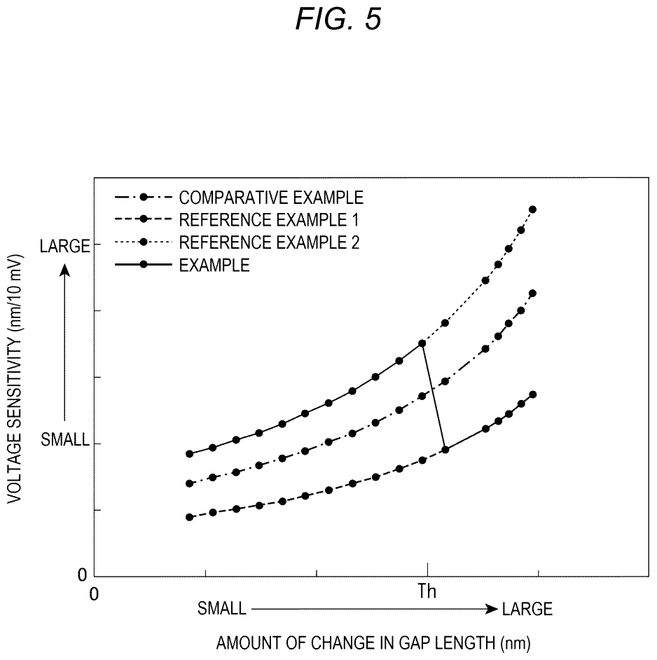

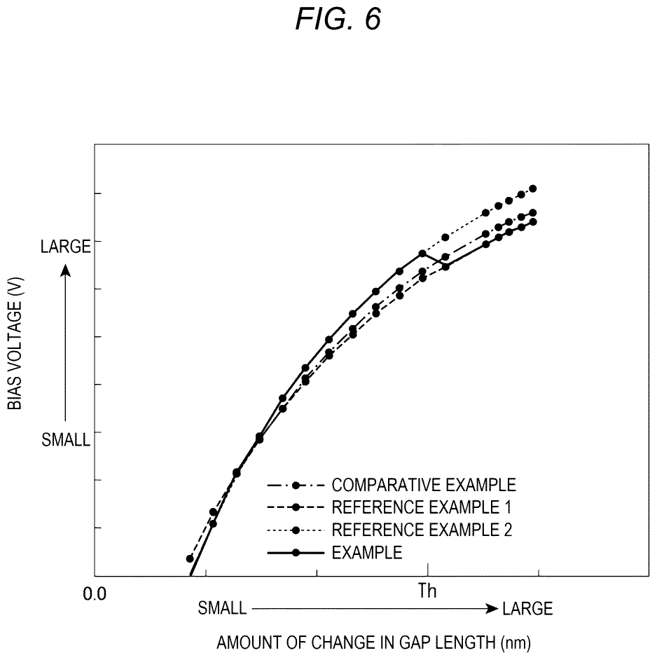

Changes in the voltage sensitivity and the bias voltage in the electrostatic actuator 6 will be described with reference to FIGS. 5 and 6. Note in the following description that Example, Reference Example 1, Reference Example 2, and Comparative Example are used.

In Example, the variable wavelength interference filter 1 according to the present embodiment is used to acquire the voltage sensitivity and the bias voltage provided when the gap target value Gt is changed for each of the predetermined intervals. Note in Example that when the gap target value Gt is greater than or equal to the first threshold, the operation mode of the third electrostatic actuator 630 is switched from the bias drive mode to the feedback control mode.

In Reference Example 1, the variable wavelength interference filter 1 according to the present embodiment is used to acquire the voltage sensitivity and the bias voltage provided when the gap target value Gt is changed for each of the predetermined intervals with the operation mode of the third electrostatic actuator 630 fixed to the bias drive mode.

In Reference Example 2, the variable wavelength interference filter 1 according to the present embodiment is used to acquire the voltage sensitivity and the bias voltage provided when the gap target value Gt is changed for each of the predetermined intervals with the operation mode of the third electrostatic actuator 630 fixed to the feedback control mode.

Comparative Example has a configuration in which the third electrostatic actuator 630 and the voltage switcher 94 are omitted from the variable wavelength interference filter 1 according to the present embodiment. Note that the area of the bias electrode 61 in Comparative Example and the area of the bias electrode 61 in Example are assumed to be substantially equal to each other. It is further assumed that the area of the control electrode 62 in Comparative Example is greater than the area of each of the control electrode 62 and the variable electrode 63 in Example, and is smaller than or equal to the sum of the areas of the control electrode 62 and the variable electrode 63 in Example. In Comparative Example, the voltage sensitivity and the bias voltage are acquired provided when the gap target value Gt is changed for each of the predetermined intervals.

FIGS. 5 and 6 show changes in the voltage sensitivity and the bias voltage provided when the gap target value Gt is changed for each of the predetermined intervals in Example, Reference Example 1, Reference Example 2, and Comparative Example. Note that the horizontal axis in FIGS. 5 and 6 showing multiple graphs indicates the amount of change in the gap length that occurs when the gap length G is changed in accordance with the gap target value Gt, the vertical axis in FIG. 5 indicates the voltage sensitivity of the electrostatic actuator 6, and the vertical axis in FIG. 6 indicates the bias voltage value. FIGS. 5 and 6 also show the amount of change in the gap length (threshold Th) corresponding to the first threshold of the gap target value Gt.

In each of Reference Examples 1 and 2 and Comparative Example, the voltage sensitivity increases as the amount of change in the gap length increases, as shown in FIG. 5.

In Example, when the amount of change in the gap length is smaller than the threshold Th, the voltage sensitivity is ensure to be higher than that in Comparative Exampled, and when the amount of change in the gap length is greater than or equal to the threshold Th, the voltage sensitivity is suppressed to a value lower than that in Comparative Example. Specifically, the voltage sensitivity provided when the amount of change in the gap length is greater than or equal to the threshold Th is suppressed to values comparable to those provided when the amount of change in the gap length is smaller than the threshold Th.

It is therefore clear in Example that the voltage sensitivity of the electrostatic actuator 6 can be adjusted in accordance with the amount of change in the gap length.

In each of the Reference Examples 1 and 2 and Comparative Example, the bias voltage value V_{b} required to achieve the gap target value Gt increases as the amount of change in the gap length increases, as shown in FIG. 6.

In Example, when the amount of change in the gap length is smaller than the threshold Th, the bias voltage value V_{b} required to achieve the gap target value Gt increases as the amount of change in the gap length increases, as in Reference Example 1. However, when the amount of change in the gap length is greater than or equal to the threshold Th, the bias voltage value V_{b} required to achieve the gap target value Gt is suppressed to values smaller than those in Reference Example 1 and Comparative Example.

It is therefore clear in Example that the variable wavelength interference filter 1 can be driven at a low voltage when the amount of change in the gap length is large.

### Effects and Advantages of Present Embodiment

(1) As described above, the variable wavelength interference filter 1 according to the present embodiment includes the first reflection film 4 and the second reflection film 5 facing each other, and the electrostatic actuator 6, which changes the gap length G between the first reflection film 4 and the second reflection film 5, and the electrostatic actuator 6 includes the bias electrode 61, to which the bias voltage corresponding to the target value of the gap length G (that is, gap target value Gt) is applied, the control electrode 62, to which the control voltage subjected to feedback control based on the gap length G and the gap target value Gt is applied, and the variable electrode 63, to which one of the bias voltage and the control voltage is applied in a switchable manner.

In the configuration described above, using the bias electrode 61, to which the bias voltage is applied, and the control electrode 62, to which the control voltage is applied, as the electrostatic actuator 6, allows coarse adjustment and fine adjustment of the gap length G, so that fine wavelength adjustment in a wide wavelength band can be made in the simple configuration.

Furthermore, in the variable wavelength interference filter 1 according to the present embodiment, using the variable electrode 63, to which one of the bias voltage and the control voltage is applied in a switchable manner, as the electrostatic actuator 6 allows a change in the ratio between the area of the electrode region to which the bias voltage is applied and the area of the electrode region to which the control voltage is applied in the electrostatic actuator 6. For example, when the gap target value Gt is large, ensuring a large proportion of the area of the electrode region to which the bias voltage is applied in the electrostatic actuator 6 allows suppression of a decrease in the voltage sensitivity of the electrostatic actuator 6. As a result, the influence of disturbance on the voltage sensitivity can be suppressed. When the gap target value Gt is small, reducing the proportion of the area of the electrode region to which the bias voltage is applied in the electrostatic actuator 6 allows suppression of an increase in the voltage sensitivity of the electrostatic actuator 6. As a result, fine adjustment of the gap length G is readily made.

The variable wavelength interference filter 1 according to the present embodiment, in which the voltage sensitivity of the electrostatic actuator 6 can be adjusted in accordance with the gap target value Gt while the electrostatic actuator 6 makes the coarse adjustment and the fine adjustment of the gap length G, therefore allows improvement in the accuracy of the wavelength adjustment in a wide wavelength band.

In the variable wavelength interference filter 1 according to the present embodiment, even when the gap target value Gt is large, ensuring a large proportion of the area of the electrode to which the bias voltage is applied in the electrostatic actuator 6 allows reduction in the maximum voltage value required for the bias voltage. That is, the variable wavelength interference filter 1 according to the present embodiment can be driven at a low voltage even when the gap target value Gt is large, so that the accuracy of the wavelength adjustment can be improved. Alternatively, the variable wavelength interference filter 1 according to the present embodiment allows an increase in the range over which the wavelength adjustment can be made.
(2) When the variable wavelength interference filter 1 according to the present embodiment is viewed along the thickness direction, the bias electrode 61, the control electrode 62, and the variable electrode 63 are arranged concentrically around the first reflection film 4 or the second reflection film 5.

The thus configured bias electrode 61, control electrode 62, and variable electrode 63 can improve the balance between the electrostatic forces generated thereby, and can uniformly adjust the gap length G between the first reflection film 4 and the second reflection film 5.
(3) When the electrostatic actuator 6 in the present embodiment is viewed along the thickness direction, the bias electrode 61, the variable electrode 63, and the control electrode 62 are arranged in this order outward in the radial direction from the side facing the first reflection film 4 or the second reflection film 5.

According to the configuration described above, when the bias voltage is applied to the variable electrode 63, the sensitivity of the electrostatic actuator 6 to the bias voltage can be preferably improved.
(4) The area of the bias electrode 61 in the present embodiment is greater than the area of each of the control electrode 62 and the variable electrode 63.

According to the configuration described above, the coarse adjustment and the fine adjustment of the gap length G can be made in a well-balanced manner.
(5) The optical module 101 according to the present embodiment includes the variable wavelength interference filter 1 described above and the filter driver 9, which drives the electrostatic actuator 6, and the filter driver 9 includes the bias driver 91, which applies the bias voltage to the bias electrode 61, the gap detector 92, which detects the gap length G between the first reflection film 4 and the second reflection film 5, the feedback controller 93, which applies the control voltage to the control electrode 62 in accordance with the gap length G detected by the gap detector 92, and the voltage switcher 94, which applies one of the bias voltage and the control voltage to the variable electrode 63 in a switchable manner.

The configuration described can above preferably provide the aforementioned advantages of the variable wavelength interference filter 1.
(6) In the present embodiment, the voltage switcher 94 switches the voltage applied to the variable electrode 63 between the bias voltage and the control voltage based on the result of the comparison between the gap target value Gt, which is a target value of the gap length G, and the first threshold.

The configuration described above allows preferable adjustment of the voltage sensitivity of the electrostatic actuator 6.
(7) The method for driving the variable wavelength interference filter 1 according to the present embodiment includes changing the gap length G by applying the bias voltage determined for each gap target value Gt, which is a target value of the gap length G between the first reflection film 4 and the second reflection film 5, to the bias electrode 61 (step S7), adjusting the gap length G between the first reflection film 4 and the second reflection film 5 by detecting the gap length G and applying the control voltage subjected to feedback control based on the detected gap length G and the gap target value Gt to the control electrode 62 (step S8), selecting one of the bias voltage and the control voltage as the selected voltage to be applied to the variable electrode 63 based on the target value of the gap length G (steps S2 to S5), and assisting a change or adjustment of the gap length G by applying the selected voltage to the variable electrode 63 at the time of voltage application to the bias electrode 61 or the control electrode 62.

The method described above can improve the accuracy of the wavelength adjustment in a wide wavelength band, as in the advantages provided by the variable wavelength interference filter 1 described above.

### VARIATIONS

The present disclosure is not limited to the embodiment described above, and variations, improvements, and other modifications to the extent that the advantages of the present disclosure are achieved fall within the scope of the present disclosure.

### Variation 1

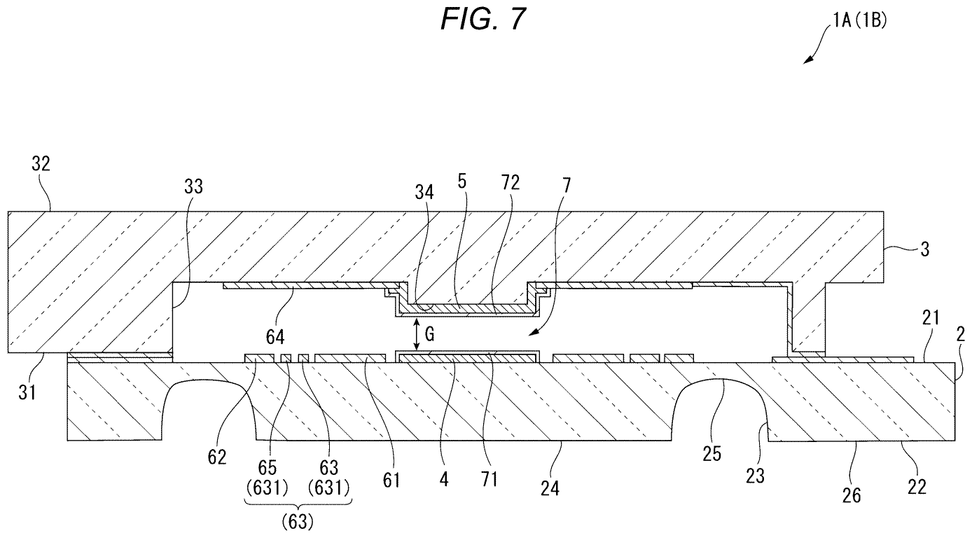

A variable wavelength interference filter 1A according to a variation may include a variable electrode 63 configured in the same manner as in the first embodiment, and a variable preliminary electrode 65, which is an electrode different from the variable electrode 63, as shown in FIG. 7. The variable auxiliary electrode 65 can be disposed concentrically around the center axis C between the variable electrode 63 and the control electrode 62. The variable auxiliary electrode 65 is not necessarily disposed in the region between the bias electrode 61 and the control electrode 62, and may be disposed in a region inside the bias electrode 61 or a region outside the control electrode 62.

One of the bias voltage and the control voltage is applied in a switchable manner to the variable auxiliary electrode 65, as in the case of the variable electrode 63. The variable auxiliary electrode 65 may be controlled independently of the variable electrode 63. For example, the voltage switcher 94 may be configured to switch the voltage applied to the variable auxiliary electrode 65 between the bias voltage and the control voltage based on a second threshold different from the first threshold corresponding to the variable electrode 63. That is, the voltage switcher 94 may apply the bias voltage to the variable auxiliary electrode 65 when the gap target value Gt is smaller than the second threshold (second threshold>first threshold, for example), and may apply the control voltage to the variable auxiliary electrode 65 when the gap target value Gt is greater than or equal to the second threshold.

The variation described above allows finer adjustment of the voltage sensitivity of the electrostatic actuator 6.

### Variation 2

In the variable wavelength interference filter 1A according to the variation, the bias electrode 61, the control electrode 62, and the variable electrode 63 may be provided at the first substrate 2, and the ground electrode 64 may be provided at the second substrate 3, as shown in FIG. 7. In this case, the bias electrode 61 may be provided at the movable portion 24 of the first substrate 2, and the control electrode 62 may be provided at the diaphragm portion 25 of the first substrate 2. The variable electrode 63 and the variable auxiliary electrode 65 may be provided at either the movable portion 24 or the diaphragm portion 25 of the first substrate 2.

### Variation 3

In the variable wavelength interference filter 1A according to the variation, the first reflection film 4 and the second reflection film 5 may each be configured, for example, with a metal film made, for example, of Ag or an alloy film made, for example, of an Ag alloy in place of a dielectric multilayer film, as shown in FIG. 7. In this case, the first detection electrode 71 may be provided on the first reflection film 4, and the second detection electrode 72 may be provided on the second reflection film 5.

### Variation 4

In the embodiment described above, the variable electrode 63 may be divided into multiple electrodes. For example, in a variable wavelength interference filter 1B according to a variation, the variable electrode 63 may include multiple divided electrodes 631 as indicated by additional reference characters in FIG. 7. The multiple divided electrodes 631 are arranged concentrically around the center axis C, and one of the bias voltage and the control voltage is applied to the multiple divided electrodes 631 in a switchable manner. The multiple divided electrodes 631 are not necessarily disposed in the region between the bias electrode 61 and the control electrode 62, and may be disposed in a region inside the bias electrode 61, a region outside the control electrode 62, or regions different from each other.

### Variation 5

In the embodiment described above, when the electrostatic actuator 6 is viewed along the thickness direction of the variable wavelength interference filter 1, the bias electrode 61, the variable electrode 63, and the control electrode 62 are arranged in this order outward in the radial direction from the side facing the first reflection film 4 or the second reflection film 5, but the order in which the electrodes are arranged may be changed.

### Variation 6

In the embodiment described above, the difference in size among the areas of the bias electrode 61, the variable electrode 63, and the control electrode 62 has been described, and the difference in size among the areas may be changed in accordance with a structure that changes the gap length G between the first substrate 2 and the second substrate 3.

### Variation 7

The voltage switcher 94 in the embodiment described above is a switch capable of switching the destination to which the variable electrode 63 is coupled between the bias driver 91 and the feedback controller 93 based on the switching signal input from the microcomputer 95, but not necessarily in the present disclosure.

For example, the voltage switcher 94 may include a circuit structure capable of outputting the bias voltage and the control voltage separately from the bias driver 91 and the feedback controller 93 described above, and a switch that applies either the bias voltage or the control voltage to the variable electrode 63 in a switchable manner based on the switching signal input from the microcomputer 95. In this case, the value of the bias voltage applied to the bias electrode 61 and the value of the bias voltage applied to the variable electrode 63 in the bias drive mode may differ from each other.

### Variation 8

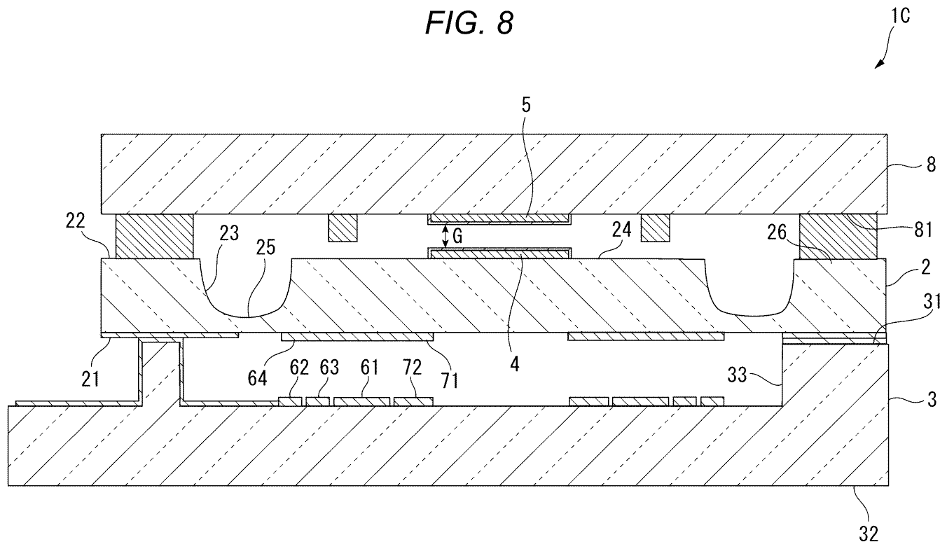

A variable wavelength interference filter 1C according to a variation may include the first substrate 2, the second substrate 3 facing the first surface 21 of the first substrate 2, and a third substrate 8 facing the second surface 22 of the first substrate 2, as shown in FIG. 8. In the variable wavelength interference filter 1C, the first reflection film 4 is provided at the second surface 22 of the first substrate 2, and the second reflection film 5 is provided on the side opposite the second substrate 3 with the first substrate 2 interposed therebetween, that is, at a facing surface 81 of the third substrate 8, which faces the first substrate 2. The first reflection film 4 and the second reflection film 5 are thus disposed to face each other.

In the variable wavelength interference filter 1C according to the variation, the electrostatic actuator 6 can adjust the gap length G between the first reflection film 4 and the second reflection film 5 by attracting the first substrate 2 toward the second substrate 3 with the aid of the electrostatic attractive force.

Note in the variable wavelength interference filter 1C according to the variation that the relationship between the magnitudes of the voltages applied to the electrodes in the electrostatic actuator 6 and the magnitude of the gap length G between the first reflection film 4 and the second reflection film 5 is opposite the relationship in the embodiment described above. The relationship in terms of magnitude between the first threshold value and the gap target value Gt in the method for driving the variable wavelength interference filter 1C may therefore be opposite the relationship in the driving method described in the first embodiment.

### Summary of Present Disclosure

A variable wavelength interference filter according to a first aspect of the present disclosure includes: a pair of reflection films facing each other; and an electrostatic actuator configured to change a gap length between the pair of reflection films, and the electrostatic actuator includes a bias electrode to which a bias voltage corresponding to a target value of the gap length is applied, a control electrode to which a control voltage subjected to feedback control based on the gap length and the target value is applied, and a variable electrode to which one of the bias voltage and the control voltage is applied in a switchable manner.

In the first aspect described above, it is preferable that the bias electrode, the control electrode, and the variable electrode are arranged concentrically around the reflection films when viewed along a thickness direction of the reflection films.

In the first aspect described above, it is preferable that when the electrostatic actuator is viewed along the thickness direction, the bias electrode, the variable electrode, and the control electrode are sequentially arranged outward in a radial direction from a side facing the pair of reflection films.

In the first aspect described above, it is preferable that an area of the bias electrode is greater than an area of each of the control electrode and the variable electrode.

An optical module according to a second aspect of the present disclosure includes the variable wavelength interference filter described above; and a filter driver configured to drive the electrostatic actuator, and the filter driver includes a bias driver configured to apply the bias voltage to the bias electrode, a gap detector configured to detect the gap length between the pair of reflection films, a feedback controller configured to apply the control voltage to the control electrode based on the gap length detected by the gap detector, and a voltage switcher configured to apply one of the bias voltage and the control voltage to the variable electrode in a switchable manner.

In the second aspect described above, it is preferable that the voltage switcher switches the voltage applied to the variable electrode between the bias voltage and the control voltage based on a result of comparison between the target value of the gap length and a first threshold.

In the second aspect described above, it is preferable that the electrostatic actuator further includes a variable auxiliary electrode to which one of the bias voltage and the control voltage is applied in a switchable manner, and the voltage switcher is configured to switch the voltage applied to the variable auxiliary electrode between the bias voltage and the control voltage based on a result of comparison between the target value of the gap length and a second threshold different from the first threshold.

A method for driving a variable wavelength interference filter according to a third aspect of the present disclosure includes: changing a gap length between a pair of reflection films by applying a bias voltage determined for each target value of the gap length to a bias electrode; adjusting the gap length between the pair of reflection films by detecting the gap length and applying a control voltage subjected to feedback control based on the detected gap length and the target value of the gap length to a control electrode; selecting one of the bias voltage and the control voltage as a selected voltage to be applied to a variable electrode based on the target value of the gap length; and assisting a change or adjustment of the gap length by applying the selected voltage to the variable electrode at the time of voltage application to the bias electrode or the control electrode.

What is claimed is:

1. A variable wavelength interference filter comprising:
a pair of reflection films facing each other; and
an electrostatic actuator configured to change a gap length between the pair of reflection films,
wherein the electrostatic actuator includes
a bias electrode to which a bias voltage corresponding to a target value of the gap length is applied,
a control electrode to which a control voltage subjected to feedback control based on the gap length and the target value is applied, and
a variable electrode to which one of the bias voltage and the control voltage is applied.

2. The variable wavelength interference filter according to claim 1, wherein
the bias electrode, the control electrode, and the variable electrode are arranged concentrically around the reflection films when viewed along a thickness direction of the reflection films.

3. The variable wavelength interference filter according to claim 2, wherein
when the electrostatic actuator is viewed along the thickness direction, the bias electrode, the variable electrode, and the control electrode are sequentially arranged outward in a radial direction from a side facing the pair of reflection films.

4. The variable wavelength interference filter according to claim 1, wherein
an area of the bias electrode is greater than an area of each of the control electrode and the variable electrode.

5. An optical module comprising:
the variable wavelength interference filter according to claim 1; and
a filter driver configured to drive the electrostatic actuator,
wherein the filter driver includes
a bias driver configured to apply the bias voltage to the bias electrode,
a gap detector configured to detect the gap length between the pair of reflection films,
a feedback controller configured to apply the control voltage to the control electrode based on the gap length detected by the gap detector, and
a voltage switcher configured to apply one of the bias voltage and the control voltage to the variable electrode in a switchable manner.

6. The optical module according to claim 5, wherein
the voltage switcher switches the voltage applied to the variable electrode between the bias voltage and the control voltage based on a result of comparison between the target value of the gap length and a first threshold.

7. The optical module according to claim 6, wherein
the electrostatic actuator further includes a variable auxiliary electrode to which one of the bias voltage and the control voltage is applied, and
the voltage switcher is configured to switch the voltage applied to the variable auxiliary electrode between the bias voltage and the control voltage based on a result of comparison between the target value of the gap length and a second threshold different from the first threshold.

8. A method for driving a variable wavelength interference filter, the method comprising:
changing a gap length between a pair of reflection films by applying a bias voltage corresponding to a target value of the gap length to a bias electrode;
adjusting the gap length between the pair of reflection films by applying a control voltage subjected to feedback control based on the detected gap length and the target value to a control electrode;
selecting one of the bias voltage and the control voltage as a selected voltage based on the target value; and
assisting adjustment of the gap length by applying the selected voltage to a variable electrode at the time of voltage application to the bias electrode or the control electrode.
